(19) United States
(12) Patent Application Publication
(10) Pub. No.: US 2024/0214673 A1
(43) Pub. Date: Jun. 27, 2024

(54) IMAGE SYSTEM

(71) Applicant: SigmaStar Technology Ltd., Xiamen (CN)

(72) Inventor: Ming-Hui PENG, Taiwan (TW)

(21) Appl. No.: 18/505,351

(22) Filed: Nov. 9, 2023

(30) Foreign Application Priority Data
Dec. 23, 2022 (CN) 202211663147.X

(51) Int. Cl. H04N 23/66; H04N 5/262

(52) U.S. Cl. CPC H04N 23/66; H04N 5/2624

(57) ABSTRACT

An image system includes multiple data transmitting interface circuits, multiple video input interface circuits and an auto-exposure control circuit. Each of the data transmitting circuits is triggered according to a first control signal and a second control signal to provide exposure parameter data to a corresponding one of multiple image sensors. The video input interface circuits receive multiple sets of image data from the image sensors, respectively, wherein the second control signal is associated with a frame timing of at least one set of the image data. The auto-exposure control circuit receives the image data from the video input interface circuits, updates the exposure parameter data according to the image data, and generates the first control signal after the exposure parameter data is updated.

This application claims the benefit of China application Serial No. CN202211663147.X, filed on Dec. 23, 2022, the subject matter of which is incorporated herein by reference.

### BACKGROUND OF THE INVENTION

### Field of the Invention

The present application relates to an image system, and more particularly to an image stitching system capable of simultaneously updating multiple image sensors.

### Description of the Related Art

In a current image stitching system, a central processor in the system is used to sequentially update exposure parameters of multiple image sensors. Thus, new exposure parameters of the multiple image sensors may take effect in different periods, in a way a stitched image obtained by stitching multiple images captured according to different exposure parameters of the multiple sensors may have a poor image quality. In addition, if there are a large number of image sensors to be processed, the task loading of the central processor is increased, hence leading to degraded overall operation efficiency.

### SUMMARY OF THE INVENTION

In some embodiments, it is an object of the present application to provide an image system to improve the issues of the prior art.

In some embodiments, an image system includes multiple data transmitting interface circuits, multiple video input interface circuits and an auto-exposure control circuit. Each of the data transmitting circuits is triggered according to a first control signal and a second control signal to provide exposure parameter data to a corresponding one of multiple image sensors. The multiple video input interface circuits receive multiple sets of image data from the image sensors, respectively, wherein the second control signal is associated with a frame timing of at least one set of the image data. The auto-exposure control circuit receives the image data from the multiple video input interface circuits, updates the exposure parameter data according to the image data, and generates the first control signal after the exposure parameter data is updated.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1A is a schematic diagram of an image system according to some embodiments of the present application;

FIG. 1B is a waveform diagram of related frame timings in FIG. 1A according to some embodiments of the present application;

FIG. 2A is a schematic diagram of an image system according to some embodiments of the present application;

FIG. 2B is a schematic diagram of a video input interface circuit in FIG. 2A according to some embodiments of the present application;

FIG. 2C is an operation flowchart of a timing detector in FIG. 2B according to some embodiments of the present application;

FIG. 3 is a schematic diagram of an image system according to some embodiments of the present application;

FIG. 4 is a schematic diagram of an image system according to some embodiments of the present application;

FIG. 5 is a schematic diagram of an image system according to some embodiments of the present application;

FIG. 6 is a schematic diagram of an image system according to some embodiments of the present application; and

FIG. 7 is a schematic diagram of an image system according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

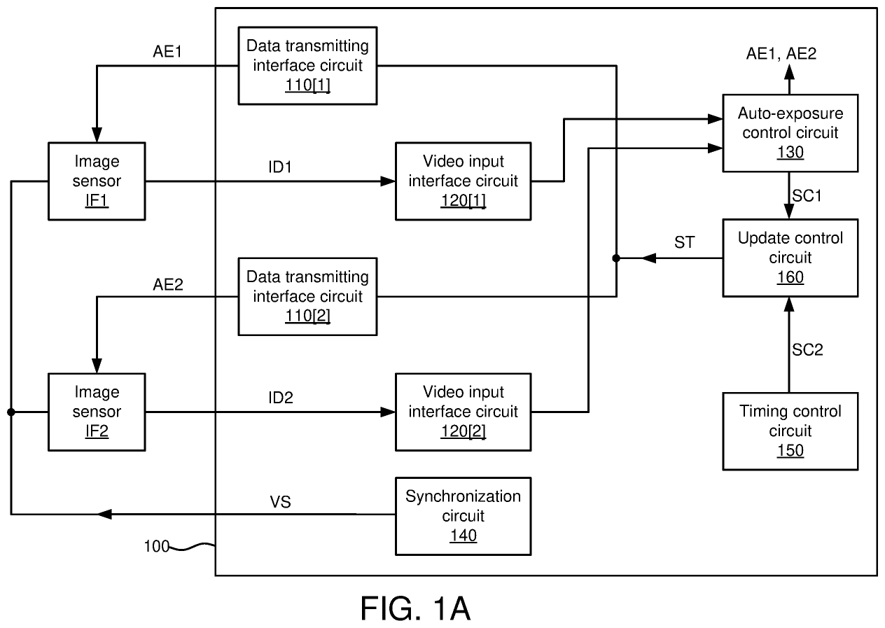

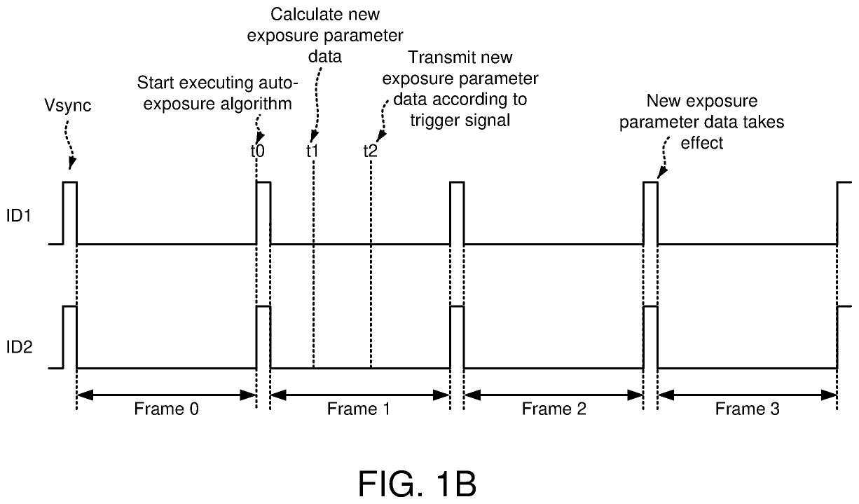

FIG. 1A shows a schematic diagram of an image system 100 according to some embodiments of the present application. In some applications, the image system 100 can control multiple image sensors IF1 and IF2 to perform synchronous capturing to generate multiple sets of image data ID1 and ID2, and combine (for example, by means of stitching) the image data ID1 and ID2 into one single image.

The image system 100 includes multiple data transmitting interface circuits 110[1] and 110[2], multiple video input interface circuits 120[1] and 120[2], an auto-exposure control circuit 130, a synchronization circuit 140, a timing control circuit 150 and an update control circuit 160. The data transmitting interface circuits 110[1] and 110[2] are coupled to the image sensors IF1 and IF2, respectively. In some embodiments, each of the data transmitting interface circuits 110[1] and 110[2] may be, for example but not limited to, an inter-integrated circuit (I2C) bus interface circuit. Each of the data transmitting interface circuits 110[1] and 110[2] may transmit exposure parameter data to a corresponding one of the image sensors IF1 and IF2.

More specifically, the data transmitting interface circuit 110[1] may transmit exposure parameter data AE1 to the image sensor IF1, and the data transmitting interface circuit 110[2] may transmit exposure parameter data AE2 to the image sensor IF2. The exposure parameter data includes control parameters to be applied to the corresponding image sensor in subsequent capturing operations, for example but not limited to, exposure time, shutter speed and amplification gain.

The video input interface circuits 120[1] and 120[2] are coupled to the image sensors IF1 and IF2, respectively. Each of the video input interface circuits 120[1] and 120[2] may receive a corresponding set of image data from the corresponding one of the image sensors IF1 and IF2. More specifically, the video input interface circuit 120[1] may receive the image data ID1 from the image sensor IF1, and the video input interface circuit 120[2] may receive the image data ID2 from the image sensor IF2.

The auto-exposure control circuit 130 may receive the sets of image data ID1 and ID2 from the video input interface circuits 120[1] and 120[2], and execute an auto-exposure algorithm according to the image data ID1 and ID2 so as to determine whether to update the exposure parameter data AE1 and AE2. For example, if the auto-exposure control circuit 130 determines that the brightness of image content of the sets of image data ID1 and ID2 is too low, the auto-exposure control circuit 130 may determine to increase the exposure time of the image sensors IF1 and IF2 and accordingly update the exposure parameter data AE1 and AE2. After the exposure parameter data AE1 and AE2 are updated, the auto-exposure control circuit 130 further outputs a control signal SC1, which indicates that the exposure parameter data AE1 and AE2 have been updated.

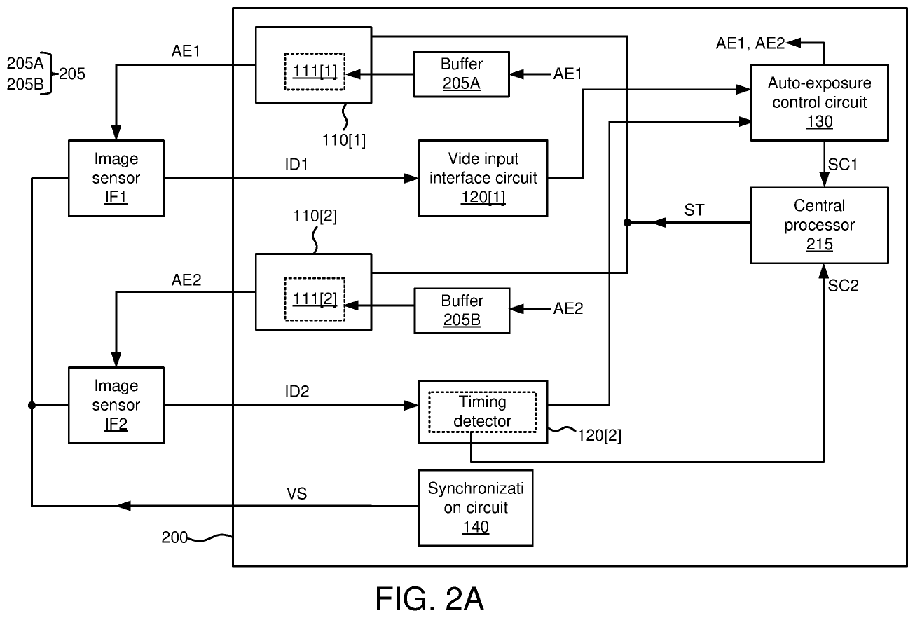

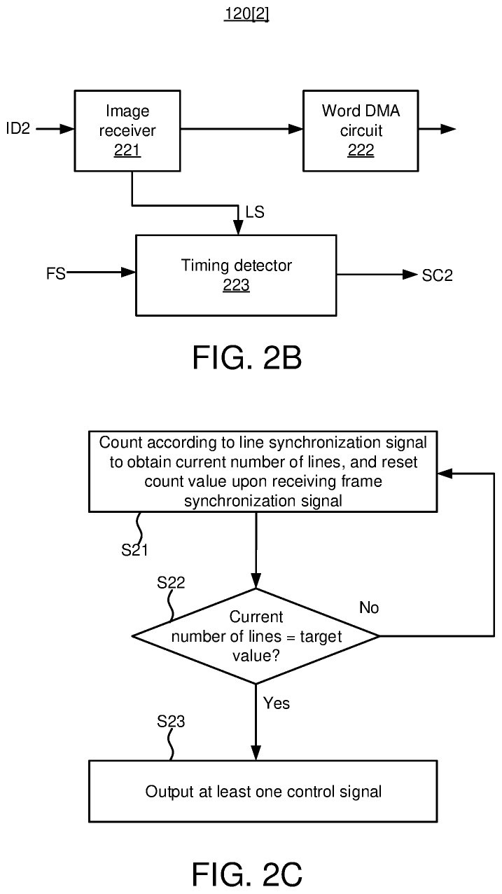

In some embodiments, the auto-exposure control circuit 130 may include an image processing circuit (not shown) and a processing circuit (not shown) executing the auto-exposure algorithm. The image processing circuit may receive the sets of image data ID1 and ID2 and process the image data ID1 and ID2 to generate multiple sets of image information (for example but not limited to, brightness distribution statistics, grayscale values, saturation and contrast). The processing circuit may execute the auto-exposure algorithm according to the image information so as to determine whether to update the exposure parameter data AE1 and AE2. In some embodiments, the processing circuit executing the auto-exposure algorithm may be, for example but not limited to, a central processor (for example, the central processor 215 in FIG. 2) of the system.

The synchronization circuit 140 generates a synchronization signal VS to control the image sensors IF1 and IF2 to perform capturing operations simultaneously so as to synchronously generate the image data ID1 and ID2. In some embodiments, the synchronization circuit 140 may be a slave controller of the image sensors IF1 and IF2. The timing control circuit 150 generates at least one control signal SC2 according to the sets of image data ID1 and ID2, wherein the at least one control signal SC2 is associated with a timing of an image frame of the image data ID1 and ID2. The update control circuit 160 generates a trigger signal ST according to the control signal SC1 and the at least one control signal SC2. As such, the data transmitting interface circuits 110[1] and 110[2] may simultaneously transmit the updated exposure parameter data AE1 and AE2 to the image sensors IF1 and IF2 according to the trigger signal ST, so that the image sensors IF1 and IF2 perform subsequent capturing operations based on the update exposure parameter data AE1 and AE2.

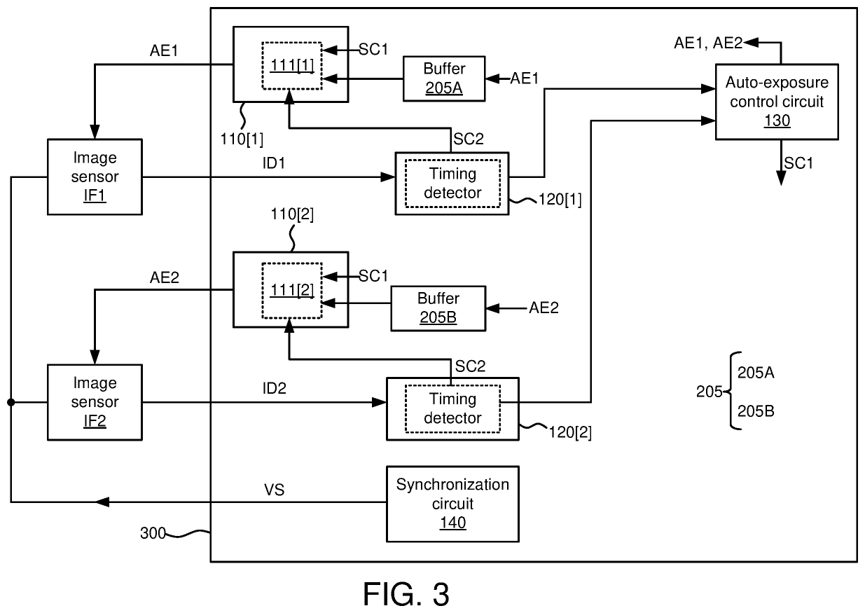

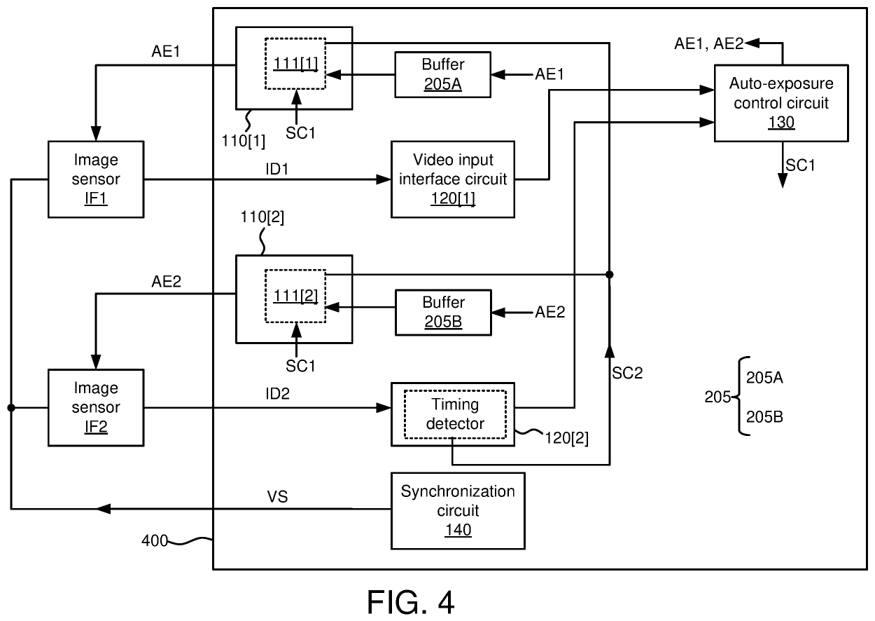

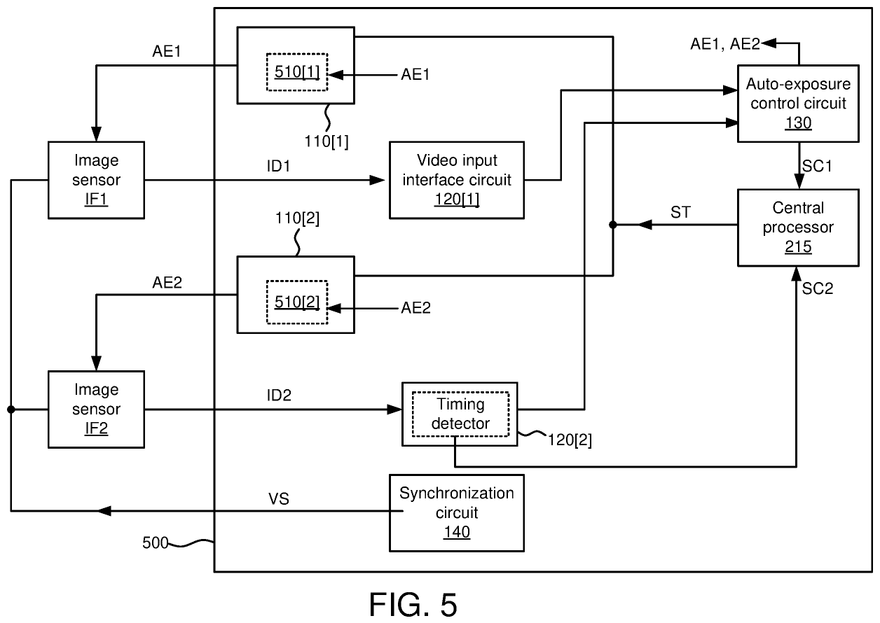

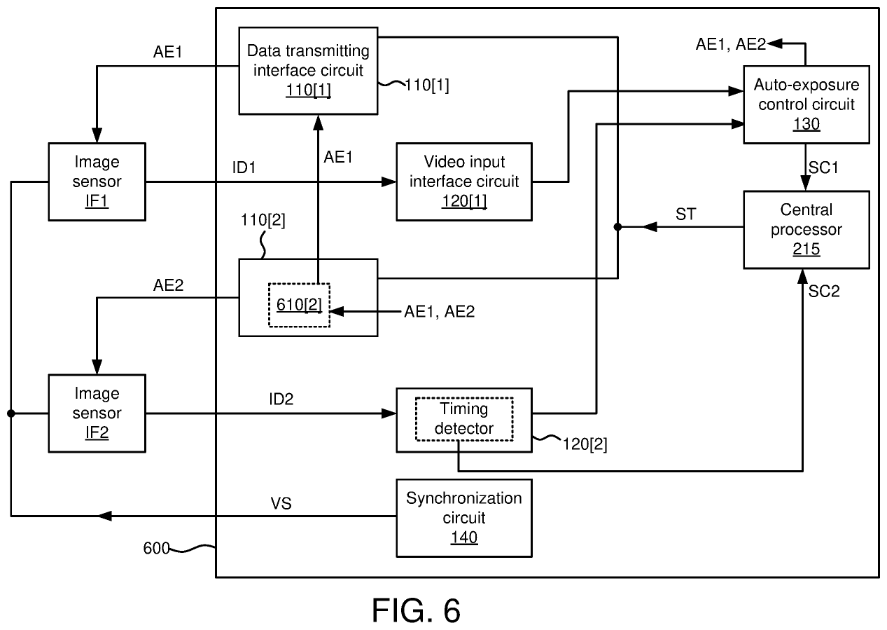

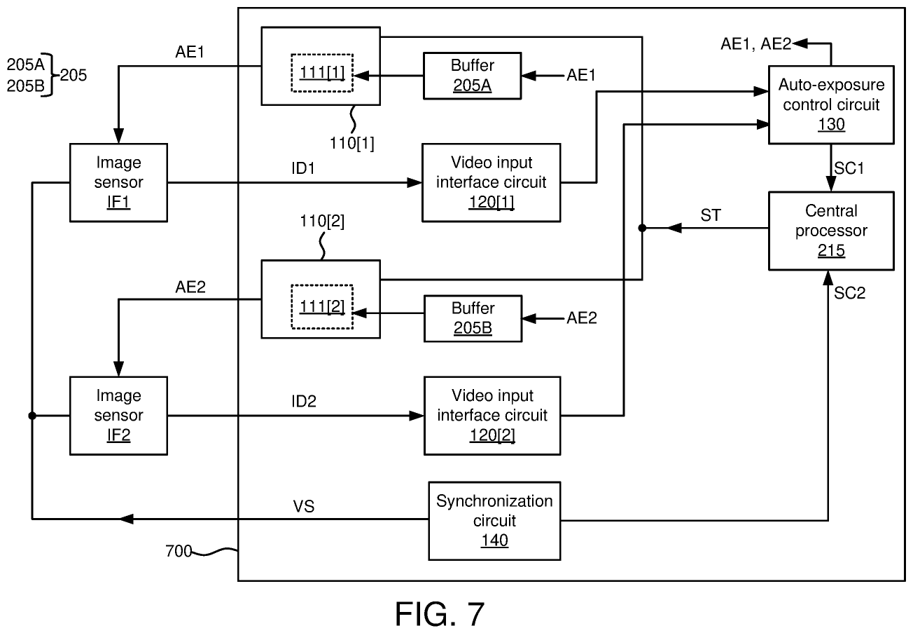

In different embodiments, the operation of the timing control circuit 150 may be performed by an independent circuit, be performed by at least one of the video input interface circuits 120[1] and 120[2] (that is, the function of the timing control circuit 150 is integrated into the video input interface circuits 120[1] and 120[2], as shown in FIG. 2A, FIG. 3, FIG. 4, FIG. 5 or FIG. 6), or be performed by the synchronization circuit 140 (that is, the function of the timing control circuit 150 is integrated into the synchronization circuit 140, as shown in FIG. 7). In different embodiments, the update control circuit 160 may be implemented by an independent circuit (for example, the central processor 215 in FIG. 2A, FIG. 5, FIG. 6 or FIG. 7), or be implemented by the data transmitting interface circuits 110[1] and 110[2] (that is, the function of the timing control circuit 150 is integrated into the data transmitting interface circuits 110[1] and 110[2], as shown in FIG. 3 or FIG. 4).

With the configuration above, the image sensors IF1 and IF2 can load the update exposure parameter data AE1 and AE2 within the same period of time, and start performing subsequent capturing operations. As such, it is ensured that the image sensors IF1 and IF2 can switch to generate the subsequent image data ID1 and ID2 based on the exposure parameter data AE1 and AE2 in the same period of time, so as to achieve image content of similar image qualities.

FIG. 1B shows a waveform diagram of frame timings associated with the sets of image data ID1 and ID2 in FIG. 1A according to some embodiments of the present application. As described above, the image sensors IF1 and IF2 are controlled by the synchronization signal VS and simultaneously generate the sets of image data ID1 and ID2. Each set of the image data ID1 and ID2 may include multiple frames 0 to 3, and the period of each frame may be set by a vertical synchronization signal Vsycn.

In this example, at a timing to (for example, a timing at which the frame 0 ends), the auto-exposure control circuit 130 finishes receiving the frames 0 of each of the sets of image data ID1 and ID2, and starts to determine according to the image content of the frames 0 whether to adjust the exposure parameter data AE1 and AE2. At a timing t1 (within the period of the frame 1), the auto-exposure control circuit 130 calculates new exposure parameter data AE1 and AE2 and generates the control signal SC1. At a timing t2 (within the period of the frame 1), the timing control circuit 150 generates the at least one control signal CS2 according to the frame timing of at least one of the image data ID1 and the image data ID2, such that the update control circuit 160 generates the trigger signal ST according to the control signal ST1 and the at least one control signal ST2. In this case, the data transmitting interface circuits 110[1] and 110[2] may transmit the updated exposure parameter data AE1 and AE2 to the image sensors IF1 and IF2 according to the trigger signal ST. Next, once the frame 3 starts, the updated exposure parameter data AE1 and AE2 take effect, such that the image sensors IF1 and IF2 may perform capturing operations based on the updated exposure parameter data AE1 and AE2 to generate the frames 3 of the image data ID1 and ID2.

In some prior art, the exposure parameter data of multiple image sensors are adjusted within different periods of time, and the updated exposure parameter data may take effect in different periods, in a way the multiple image sensors start to use the updated exposure parameter data in different frame periods to perform capturing operations. In some frame periods, it is possible that some image sensors use the update exposure parameter data to perform capturing operations while the some other image sensors still use the exposure parameter data before the update to perform capturing operations. As such, an image obtain after stitching appears to have poorer capturing effects within these frames (for example, the brightness of some areas may be too high). However, with the configuration in FIG. 1A, the image sensors IF1 and IF2 are allowed to load the updated exposure parameter data within the same period of time and perform capturing operations by simultaneously using the updated exposure parameter data, hence achieving better capturing effects for an image obtained after stitching.

FIG. 2A shows a schematic diagram of an image system 200 according to some embodiments of the present application. In this example, the image system 200 further includes a memory 205. The memory 205 includes a buffer 205A and a buffer 205B that are formed by different memory blocks. Moreover, the update control circuit 160 may be implemented by the central processor 215 in the system, the data transmitting interface circuit 110[1] includes a direct memory access (DMA) circuit 111[1] and the data transmitting interface circuit 110[2] includes a DMA circuit 111[2]. In some embodiments, the memory 205 may be, for example but not limited to, a dynamic random access memory (DRAM). In some embodiments, the memory 205 is arranged outside the image system, the image system 200 is connected to the memory 205 in an external manner, and the memory 205 may be a memory shared with other circuits in the system.

The auto-exposure control circuit 130 may store the exposure parameter data AE1 to the buffer 205A in the memory 205, and store the exposure parameter data AE2 to the buffer 205B in the memory 205. The data transmitting interface circuits 110[1] and 110[2] may control the DMA circuits 111[1] and 111[2] according to the control signal SC1 and the at least one control signal ST2 to read the exposure parameter data AE1 and AE2 from the buffers 205A and 205B and transmit the exposure parameter data AE1 and AE2 to the image sensors IF1 and IF2, respectively. For example, the central processor 215 may generate the trigger signal ST according to the control signal SC1 and the control signal SC2, and the data transmitting interface circuits 110[1] and 110[2] may control the DMA circuits 111[1] and 111[2] to perform the above operation according to triggering of the trigger signal ST, respectively.

In this example, the function of the timing control circuit 150 in FIG. 1A may be integrated into one of the video input interface circuits 120[1] and 120[2]. For example, the video input interface circuit 120[2] may detect the frame timing of the image data ID2 so as to generate the at least one control signal SC2. More specifically, the video input interface circuit 120[2] further includes a timing detector (for example, the timing detector 223 in FIG. 2B), which can detect the number of lines of the image data ID2 received, and generate the at least one control signal ST2 when the number of lines meets a target value. Associated details of the operation and configuration herein are to be described with reference to FIG. 2B and FIG. 2C below.

FIG. 2B shows a schematic diagram of the video input interface circuit 120[2] in FIG. 2A according to some embodiments of the present application. The video input interface circuit 120[2] includes an image receiver 221, a word DMA circuit 222 and a timing detector 223. The image receiver 221 may receive the image data ID2, and generate a line synchronization signal LS and a frame synchronization signal FS according to the frame timing of the image data ID2. The word DMA circuit 22 may transfer the image data ID2 to an image buffer (not shown) in the memory 205. The timing detector 223 may determine, according to the line synchronization signal LS and the frame synchronization signal FS, the number of lines of the image data ID2 currently received.

It should be understood that, one frame in image data may be consisted of multiple lines, and the frame may be shown by means of sequentially processing pixels in the image data one line after another For example, when the frame synchronization signal FS transitions once (for example, as the vertical synchronization signal in FIG. 1B), it means that the frame of the image data ID2 starts. Next, if the line synchronization signal LS transitions, it means that the first line of the image data ID2 has been processed/received. Similarly, if the line synchronization signal LS transitions N times, it means that the Nth line of the image data ID2 has been processed/received. Thus, the timing detector 223 may include a line counter (not shown), which may count according to the line synchronization signal LS and the frame synchronization signal FS so as to determine the current number of lines in the image data ID2. The timing detector 223 may compare this number of lines with the target value so as to determine whether to output the at least one control signal SC2. In this example, the at least one control signal SC2 may be an interrupt request to the central processor 215.

FIG. 2C shows an operation flowchart of the timing detector 223 in FIG. 2B according to some embodiments of the present application. In operation S21, counting is performed according to the line synchronization signal LS to obtain a current number of lines, and the count value is reset upon receiving the frame synchronization signal FS. In operation S22, the current number of lines is compared with the target value so as to determine whether the current number of lines is equal to the target value. Operation S23 is performed if the current number of lines is equal to the target value, otherwise operation S21 is again performed. In operation S23, at least one control signal (that is, the at least one control signal SC2) is output.

In some embodiments, the target value may be a predetermined number of lines, and a timing corresponding to the predetermined number of is time (for example, the timing t2 in FIG. 1B) that is sufficient for the auto-exposure control circuit 130 to generate the update exposure parameter data AE1 or AE2. In different embodiments, according to actual requirements, the target value may also be set to be the number of lines corresponding to a frame starting time or a frame end time; however, the present application is not limited to the examples above.

FIG. 3 shows a schematic diagram of an image system 300 according to some embodiments of the present application. In this example, the function of the update control circuit 160 in FIG. 1A may be integrated into the data transmitting interface circuits 110[1] and 110[2], and the function of the timing control circuit 150 in FIG. 1B may be integrated into the video input interface circuits 120[1] and 120[2].

More specifically, a timing detector (for example, the timing detector 223 in FIG. 2B) of each of the video input interface circuits 120[1] and 120[2] may generate a corresponding one of the at least one control signal SC2 according to the corresponding image data, and transmit the corresponding one of the at least one control signal SC2 to the corresponding data transmitting interface circuit, such that the corresponding data transmitting interface circuit may provide the corresponding exposure parameter data to the corresponding image sensor. For example, the video input interface circuit 120[1] generates a signal of the at least one control signal SC2 according to the image data ID1, and transmits the signal to the data transmitting interface circuit 110[1]. Thus, the data transmitting interface circuit 110[1] may be triggered according to this signal to load the exposure parameter data AE1 to the image sensor IF1 that generates the image data ID1. Similarly, the operations among the video input interface circuit 120[2], the data transmitting interface circuit 110[2] and the image sensor IF2 can be deduced accordingly.

As described above, the function of the update control circuit 160 in FIG. 1A may be integrated into the data transmitting interface circuits 110[1] and 110[2]. For example, a DMA circuit (for example, the DMA circuits 111[1] and 111[2]in FIG. 2B) of each of the data transmitting interface circuits 110[1] and 110[2] may be triggered according to the control signal SC1 and the corresponding one of the at least one control signal SC2, so as to read the corresponding exposure parameter data AE1 or AE2 from the memory 205 and transmit the corresponding exposure parameter data AE1 or AE2 to the corresponding image sensor IF1 or IF2 through the data transmitting interface circuit 110[1] or 110[2]. Thus, the central processor 215 can be prevented from receiving too many interrupt requests, hence improving the processing efficiency of the central processor 215.

In some embodiments, the configuration in FIG. 3 is applicable to situations where the image sensor IF1 and the image sensor IF2 are different types of image sensors. For example, in some applications, the image sensor IF1 may be a common image sensor, and the image sensor IF2 is an infrared sensor. In this case, certain transmission or processing delays may exists between the hardware of these two types of sensors. By using the respectively corresponding sets of data transmitting interface circuits and video input interface circuits to directly control the image sensors IF1 and IF2, the central processor 215 is prevented from receiving an interrupt request that has a longer delay time (for example, needing to wait for an image sensor with a longer delay time to complete its operation).

FIG. 4 shows a schematic diagram of an image system 400 according to some embodiments of the present application. Different from FIG. 3, in this example, a corresponding one of the video input interface circuits 120[1] and 120[2] may generate the at least one control signal SC2 corresponding to the image data ID2, and transmit the at least one control signal SC2 to the data transmitting interface circuits 110[1] and 110[2]. For example, a timing detector (for example, the timing detector 223 in FIG. 2B) in the video input interface circuit 120[2] may generate the at least one control signal SC2 corresponding to the image data ID2, and transmit the at least one control signal SC2 to the data transmitting interfaces circuits 110[1] and 110[2]. Thus, the data transmitting interfaces circuits 110[1] and 110[2] may transmit the corresponding exposure parameter data AE1 or AE2 to the corresponding image sensor IF1 or IF2 according to the control signal SC1 and the at least one control signal SC2.

FIG. 5 shows a schematic diagram of an image system 500 according to some embodiments of the present application. Compared to FIG. 2, the image system 500 does not use the memory 205. In this example, each of the data transmitting interfaces circuits 110[1] and 110[2] includes a buffer (respectively denoted as a buffer 510[1] and a buffer 510[2]). The buffer 510[1] and the buffer 510[2] may be formed by registers or static random access memories (SRAM). The buffer 510[1] may store the exposure parameter data AE1 to be received by the image sensor IF1, and the buffer 510[2] may store the exposure parameter data AE2 to be received by the image sensor IF2. The multiple data transmitting interfaces circuits 110[1] and 110[2] may triggered according to the trigger signal ST to load the exposure parameter data AE1 and AE2 in the buffer 510[1] and the buffer 510[2] into the image sensors IF1 and IF2, respectively.

FIG. 6 shows a schematic diagram of an image system 600 according to some embodiments of the present application. Different from FIG. 5, in this example, one of the data transmitting interface circuits 110[1] and 110[2] includes a buffer, and this buffer stores the exposure parameter data AE1 and AE2 to be received by both the image sensors IF1 and IF2. For example, the data transmitting interface circuit 110[2] includes a buffer 610[2], which may store the exposure parameter data AE1 and AE2. The buffer 610[2] may be formed by a registers or an SRAM. The data transmitting interface circuit 110[1] may read the exposure parameter data AE1 from the buffer 610[2]. In one embodiment, the buffer 610[2] may be arranged outside the data transmitting interface circuit 110[2], and be shared by the multiple data transmitting interface circuits 110[1] and 110[2].

FIG. 7 shows a schematic diagram of an image system 700 according to some embodiments of the present application. Different from FIG. 2, in this example, the function of the timing control circuit 150 in FIG. 1A (or the timing detector 223 in FIG. 2B) is integrated into the synchronization circuit 140. In other words, the synchronization circuit 140 may generate the at least one control signal ST2 according to related information (including, for example but not limited to, the timing of the vertical synchronization signal Vsync in FIG. 1B) of the synchronization signal VS. The central processor 215 may determine according to the at least one control signal SC2 and the control signal ST whether to generate the trigger signal ST.

For illustration purposes, only two image sensors are taken as an example in the embodiments above. According to actual application requirements, two or more image sensors may also be used in the embodiments above. Therefore, the number of image sensors suitable for the present application is not limited to those described in the numerous embodiments above. In the numerous embodiments above, the central processor 215 may also be implemented by an independent circuit, so as to further reduce the loading of the central processor 215. Moreover, an application scenario of image stitching is used in the numerous embodiments above to explain the image system of the present application that allows multiple image sensors to simultaneously update exposure parameter data; however, it should be noted that these embodiments are not be construed as limitations to the other application scenarios of the image system of the present application.

In conclusion, the image system according to some embodiments of the present application has numerous configurations to allow multiple image sensors to simultaneously update exposure parameter data so as to achieve a stitched image with a uniform quality. Moreover, in some configurations, the operation for updating the exposure parameter data may be integrated to other circuits or be performed by an independent circuit so as to reduce the loading of a central processor, hence improving the operation efficiency of the overall system.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An image system, comprising:
a plurality of data transmitting interface circuits, each of the data transmitting interface circuits triggered according to a first control signal and a second control signal to provide exposure parameter data to a corresponding one of a plurality of image sensors;
a plurality of video input interface circuits, receiving a plurality of sets of image data from the image sensors, respectively, wherein the second control signal is associated with a frame timing of at least one set of the image data; and
an auto-exposure control circuit, receiving the image data from the video input interface circuits, updating the exposure parameter data according to the image data, and generating the first control signal after the exposure parameter data is updated.

2. The image system according to claim 1, wherein the image data is for being stitched into one single image.

3. The image system according to claim 1, wherein the auto-exposure control circuit transits the first control signal to a central processor, the central processor generates a trigger signal according to the first control signal and the second control signal, and each of the data transmitting interface circuits is triggered according to the trigger signal so as to provide the exposure parameter data to the corresponding one of the image sensors.

4. The image system according to claim 1, wherein the exposure parameter data is stored in a memory, each of the data transmitting interface circuits comprises a direct memory access (DMA) circuit, and the DMA circuit is triggered according to the first control signal and the second control signal so as to transmit the exposure parameter data to the corresponding one of the image sensors.

5. The image system according to claim 1, wherein one of the video input interface circuits detects the frame timing of a corresponding set of the image data to generate the second control signal.

6. The image system according to claim 5, wherein the one of the video input interface circuits detects the number of lines of the corresponding set of the image data, and generates the second control signal when the number of lines meets a target number.

7. The image system according to claim 1, wherein a corresponding one of the video input interface circuits generates the second control signal according to a corresponding set of the image data, and transmits the second control signal to the data transmitting interface circuits.

8. The image system according to claim 1, wherein each of the data transmitting interface circuits comprises a buffer, and the buffer stores the exposure parameter data to be received by the corresponding one of the image sensors.

9. The image system according to claim 1, wherein one of the data transmitting interface circuits comprises a buffer, the buffer stores the exposure parameter data to be received by each of the image sensors, and the rest of the data transmitting interface circuits reads the exposure parameter data from the buffer.

10. The image system according to claim 1, further comprising:
a synchronization circuit, generating a synchronization signal to control the image sensors to synchronously generate the image data.

11. The image system according to claim 10, wherein the synchronization circuit further generates the second control signal.
